(19) United States
(12) Patent Application Publication
(10) Pub. No.: US 2024/0160138 A1
(43) Pub. Date: May 16, 2024

(54) FIXING DEVICE AND IMAGE FORMING APPARATUS INCORPORATING THE SAME

(71) Applicant: Kazuto SHIBUYA, Kanagawa (JP)

(72) Inventor: Kazuto SHIBUYA, Kanagawa (JP)

(21) Appl. No.: 18/387,468

(22) Filed: Nov. 7, 2023

(30) Foreign Application Priority Data
Nov. 14, 2022 (JP) 2022-181763

(51) Int. Cl. G03G 15/20

(52) U.S. Cl. CPC G03G 15/206; G03G 15/2064; G03G 2215/2038

(57) ABSTRACT

A fixing device includes a belt, a nip formation pad, and a pressure rotator. The belt has a loop rotatable in a sheet conveyance direction. The nip formation pad is inside the loop and includes three curved portions in the sheet conveyance direction. The three curved portions form a nip formation face. The pressure rotator presses the belt against the nip formation pad to form a fixing nip between the belt and the pressure rotator.

### CROSS-REFERENCE TO RELATED APPLICATION

This patent application is based on and claims priority pursuant to 35 U.S.C. § 119(a) to Japanese Patent Application No. 2022-181763, filed on Nov. 14, 2022, in the Japan Patent Office, the entire disclosure of which is hereby incorporated by reference herein.

### BACKGROUND

### Technical Field

Embodiments of the present disclosure relate to a fixing device and an image forming apparatus incorporating the fixing device.

### Related Art

In the related art, one type of image forming apparatus includes a fixing device. As such a fixing device, a sliding fixing device is known in the art. The sliding fixing device includes a nip formation pad, an endless belt wound around rollers, and a pressure rotator disposed opposite the nip formation pad across the endless belt to form a nip between the pressure rotator and the nip formation pad.

### SUMMARY

This specification describes an improved fixing device that includes a belt, a nip formation pad, and a pressure rotator. The belt has a loop rotatable in a sheet conveyance direction. The nip formation pad is inside the loop and includes three curved portions in the sheet conveyance direction. The three curved portions form a nip formation face. The pressure rotator presses the belt against the nip formation pad to form a fixing nip between the belt and the pressure rotator.

This specification also describes an image forming apparatus including the fixing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus including a fixing device according to an embodiment of the present disclosure;

FIG. 2 is a schematic cross-sectional view of the fixing device installed in the image forming apparatus of FIG. 1;

FIG. 3 is a schematic enlarged cross-sectional view of a nip formation pad in the fixing device of FIG. 2;

FIG. 4A is a schematic diagram illustrating a configuration of a nip formation pad according to a comparative example;

FIG. 4B is a schematic diagram illustrating a configuration of the nip formation pad of FIG. 3;

FIG. 5 is a graph illustrating a pressure distribution of the nip formation pad of FIG. 4A and a pressure distribution of the nip formation pad of FIG. 4B, where the surface pressure in the above embodiment of the present disclosure is compared with the surface pressure in the above comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to drawings, descriptions are given below of embodiments of the present disclosure. In the drawings illustrating embodiments of the present disclosure, elements or components having identical or similar functions or shapes are given similar reference numerals as far as distinguishable, and redundant descriptions are omitted.

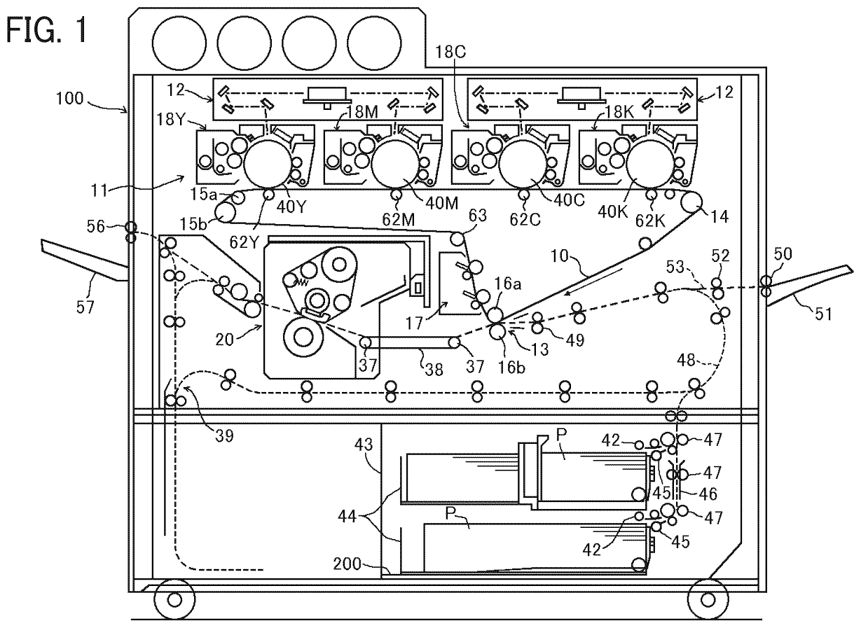

FIG. 1 is a schematic diagram illustrating an image forming apparatus 100 including a fixing device according to an embodiment of the present disclosure.

The image forming apparatus according to the present embodiment may be, for example, a printer, a copier, and a fax machine. The image forming apparatus 100 uses toner to form a toner image on a sheet medium and includes a fixing device to fix the toner image (an unfixed image) onto the sheet-like body. The image forming apparatus 100 according to the present embodiment employs a tandem intermediate transfer system and includes a fixing device 20 according to an embodiment of the present disclosure and a sheet feeding table 200 including sheet feeding trays 44 in a lower part of the image forming apparatus 100.

In the following description, the term “image forming apparatus” refers to an image forming apparatus that performs image formation by attaching developer or ink to a medium such as paper, an overhead projector (OHP) transparency, yarn, fiber, cloth, leather, metal, plastic, glass, wood, and ceramics. The term “image formation” indicates an action for providing (i.e., printing) not only an image having a meaning, such as texts and figures on a recording medium, but also an image having no meaning, such as patterns on the recording medium.

The term “sheet medium” includes not only a sheet of paper but also any medium to which toner or ink adheres such as a recording medium, recording paper, or a recording sheet, including an overhead projector (OHP) transparency sheet and textile. In the embodiments of the present disclosure described below the “sheet medium” indicates a sheet, and the size (dimension), material, or shape of the sheet described in relation to the components and units of the image forming apparatus, and the relative positions of the sheet and each of those components and units are given by way of example. The scope of the present disclosure is not limited thereto unless otherwise specified.

The image forming apparatus 100 includes a tandem image forming section 11 employing the tandem intermediate transfer system. The tandem image forming section 11 includes multiple image forming devices 18Y, 18M, 18C, and 15K aligned horizontally. Suffixes Y, M, C, and K represent yellow, magenta, cyan, and black, respectively.

The image forming apparatus 100 includes an endless belt-shaped intermediate transferor 10 situated in a substantially center portion of the image forming apparatus 100. The intermediate transferor 10 of the image forming apparatus 100 may be referred to as an intermediate transfer belt 10 in the following description. The intermediate transfer belt 10 is stretched around and supported by, for example, multiple support rollers 14, 15a, 15h, and 16a. The intermediate transfer belt 10 is rotatable clockwise in FIG. 1.

In a configuration illustrated in FIG. 1, the image forming apparatus 100 includes a belt cleaner 17 disposed downstream from a secondary transfer backup roller 16a, which is one of the support rollers, in a direction of rotation of the intermediate transfer belt 10 to clean the intermediate transfer belt 10. The belt cleaner 17 removes residual toner remaining on the intermediate transfer belt 10 after the toner image formed on the intermediate transfer belt is transferred.

Above the intermediate transfer belt 10 stretched taut between the support rollers 14 and 15a, the image forming apparatus 100 includes the four image forming devices 18Y, 18M, 18C, and 18K aligned in the direction of rotation of the intermediate transfer belt 10, which form yellow (Y), magenta (M), cyan (C), and black (K) images, respectively.

The four image forming devices 18Y, 18M, 18C, and 18K aligned laterally form the tandem image forming section 11 described above. The image forming devices 18Y, 18M, 18C, and 18K in the tandem image forming section 11 include photoconductor drums 40Y, 40M, 40C, and 40K as image bearers to bear a yellow toner image, a magenta toner image, a cyan toner image, and a black toner image, respectively.

Above the tandem image forming section 11, the image forming apparatus 100 includes two exposure devices 12. The left exposure device 12 is disposed opposite the two image forming devices 18Y and 18M, The right exposure device 12 is disposed opposite the two image forming devices 18C and 18K. Each of the exposure devices 12 employs an optical scanning system and includes a light source device such as a semiconductor laser, a semiconductor laser array, or a multi-beam light source. In addition, each of the exposure devices 12 includes a coupling optical system, a common light deflector such as a polygon mirror, and a dual-system scanning image forming optical system.

The exposure devices 12 expose the photoconductor drums 40Y, 40M, 40C, and 40K according to yellow, magenta, cyan, and black image data, forming electrostatic latent images on the photoconductor drums 40Y, 40M, 40C, and 40K, respectively. A charger, a developing device, and a photoconductor cleaner are disposed around each of the photoconductor drums 40Y, 40M, 40C, and 40K in each of the image forming devices 18Y, 18M, 18C, and 18K. The charger uniformly charges the photoconductor drum prior to exposure. The developing device develops an electrostatic latent image formed by exposure with yellow; magenta, cyan, or black toner. The photoconductor cleaner removes residual toner remaining on the photoconductor drum.

In addition, the image forming apparatus 100 includes primary transfer rollers 62Y, 62M, 62C, and 62K at primary transfer positions to transfer the yellow toner image, the magenta toner image, the cyan toner image, and the black toner image from the photoconductor drums 40′Y, 40M, 40C, and 40K onto the intermediate transfer belt 10. As a result, a full-color toner image is formed on the intermediate transfer belt 10. The primary transfer rollers 62Y, 62M, 62C, and 62K are opposite the photoconductor drums 40Y, 40M, 40C, and 40K, and the intermediate transfer belt 10 is sandwiched between the primary transfer rollers 62Y, 62M, 62C, and 62K and the photoconductor drums 40Y, 40M, 40C, and 40K, The primary transfer rollers 62Y, 62M, 62C, and 62K function as primary transferors.

Among the multiple support rollers that support the intermediate transfer belt 10, the support roller 14 is a drive roller that rotationally drives the intermediate transfer belt 10 and is connected to a motor via a drive transmission mechanism such as a gear, a pulley, or a belt. When the image forming apparatus 100 forms a black monochrome image on the intermediate transfer belt 10, a transfer mechanism moves the support rollers 15a and 15b other than the support roller 14 to separate the intermediate transfer belt 10 from the photoconductor drums 40Y, 40M, and 40C, In addition to the multiple support rollers 14, 15a, 15b, and 16a, a backup roller 63 is disposed to support the intermediate transfer belt 10 from outside the loop formed by the intermediate transfer belt 10.

A secondary transfer device 13 is disposed opposite the tandem image forming section 11 across the intermediate transfer belt 10. In the secondary transfer device 13, a secondary transfer roller 16b is pressed against the secondary transfer backup roller 16a via the intermediate transfer belt 10 and a transfer electrical field is applied to the sheet P to transfer the toner image from the intermediate transfer belt 10 onto the sheet P.

Downstream from the secondary transfer device 13 in a direction of conveyance of the sheet P. the fixing device 20 is disposed to fix the toner image transferred onto the sheet P. A conveyance belt 38 supported by two conveyance rollers 37 conveys the sheet P onto which the toner image is transferred in the secondary transfer device 13 to the fixing device 20. Instead of the conveyance belt 38, for example, a stationary guide and a conveyance roller may be used. The image forming apparatus 100 includes a sheet reversing device 39 below the tandem image forming section 11, the secondary transfer device 13 and the fixing device to reverse and convey the sheet P and print another toner image on the back side of the sheet P.

To provide a fuller understanding of the embodiments of the present disclosure, a description is now given of an image forming operation together with conveyance of the sheet P in the image forming apparatus 100, with continued reference to FIG. 1.

Initially, one of sheet feeding rollers 42 in the sheet feeding table 200 is selected and rotated to pick up and feed the sheets P from one of the multiple sheet feeding trays 44 layered in a sheet bank 43. A separation roller 45 separates a sheet P from the other sheets P resting on the sheet feeding tray 44 and feeds the sheet P to a first conveyance passage 46. A sheet feeding conveyance roller pair 47 conveys the sheet P along the first conveyance passage 46 to a second conveyance passage 48 in the image forming apparatus 100, and a leading edge of the sheet P contacts a registration roller pair 49 as a positioning roller pair, which halts the sheet temporarily.

Instead of feeding the sheet P from the sheet feeding table 200, the sheet P may be manually imported into the image forming apparatus 100 by use of a bypass feeder 51, on which a plurality of sheets are placed. A sheet feeding roller 50 is rotated to pick up the sheets from the bypass feeder 51 and send the sheets to a separation roller 52. The separation roller 52 separates the sheets one by one and sends the sheet P to a bypass conveyance passage 53. Like the sheet P conveyed from the sheet feeding table 200, the leading edge of the sheet P conveyed from the bypass feeder 51 contacts the registration roller pair 49 and stops temporarily.

Subsequently, in synchronization with the movement of the full-color toner image formed on the intermediate transfer belt 10, the registration roller pair 49 rotates to send the sheet P to a secondary transfer position between the intermediate transfer belt 10 and the secondary transfer roller 16b. Then, the full-color toner image formed on the intermediate transfer belt 10 is collectively transferred from the intermediate transfer belt 10 onto the sheet P.

The conveyance belt 38 conveys the sheet P bearing the full-color toner image to the fixing device 20 according to the present embodiment. Subsequently, the fixing device 20 applies heat and pressure to the full-color toner image on the sheet P to fix the full-color toner image onto the sheet P. An ejection roller pair 56 ejects the sheet P having the fixed toner image to an output tray 57, and the sheet P is stacked on the output tray 57.

In duplex printing, after the full-color toner image is fixed on one side of the sheet P, the sheet P is conveyed to a sheet reversing device 39, turned upside down, and conveyed, again to the secondary transfer position. At the secondary transfer position, another full-color toner image is transferred onto the back side of the sheet P. The sheet P is then conveyed to the fixing device 20 that fixes another full-color toner image onto the back side of the sheet P. The ejection roller pair 56 then ejects the sheet P to the output tray 57.

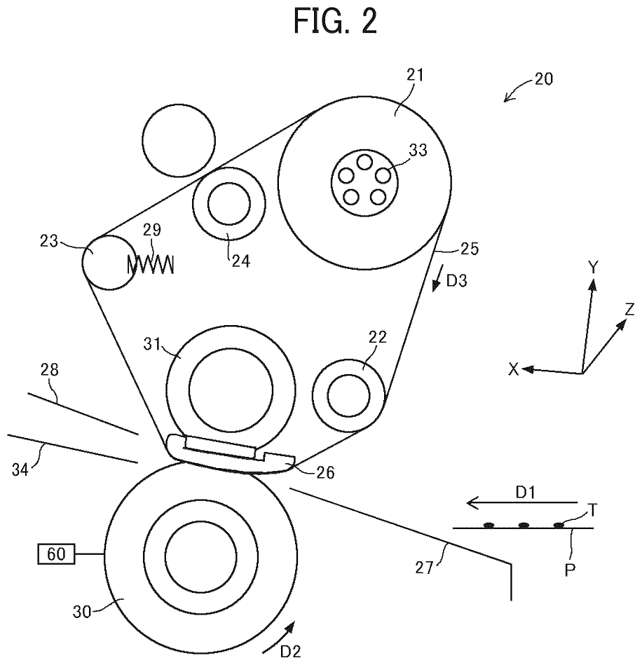

With reference to FIG. 2, the following describes the fixing device 20 according to an embodiment of the present disclosure.

As illustrated in FIG. 2, the fixing device 20 includes multiple rollers 21, 22, 23, and 24, an endless fixing belt 25 as an endless belt stretched between the rollers 21, 22, 23, and 24 and a nip formation pad 26, and a pressure roller 30 as a pressure rotator disposed so as to come into contact with and separate from the fixing belt 25. Instead of the pressure roller 30, a pressure belt may be used.

The multiple rollers 21, 22, 23, and 24 include a fixing roller 21 driven to rotate by a driver and including a heater, belt support rollers 22 and 24, and a pressure adjustment roller 23 which a biasing member 29 such as a spring presses. Instead of the driver to rotate the fixing roller 21, a motor as the driver may rotate the pressure roller 30, and the rotation of the pressure roller 30 may drive the fixing belt 25 to rotate. As a result, the loop of the fixing belt 25 rotates in the sheet conveyance direction. The pressure roller 30 is pressed against the nip formation pad 26 via the fixing belt 25 to form a fixing nip between the nip formation pad 26 and the pressure roller 30.

In FIG. 2, the pressure roller 30 contacts the fixing belt 25. The pressure roller 30 and the fixing belt 25 that contact each other heat and melt an unfixed toner image T formed on the sheet P at the nip to fix the toner image T on the sheet P.

The sheet P on which the toner image is formed enters the fixing nip from an entrance guide 27 and is ejected to an exit guide 34. A separator 28 is disposed close to the fixing belt 25 downstream from a nip exit to prevent the sheet P ejected from the fixing nip from being wound around the fixing belt 25.

The following describes the nip formation pad 26.

A frame of the fixing device 20 supports a rigid support 31 inserted into the loop of the fixing belt 25 to support and fix the nip formation pad 26 inside the loop of the fixing belt 25. Accordingly, even if the nip formation pad 26 receives a pressing force of the pressure roller 30, the nip formation pad 26 is not displaced and bent by the pressing force and stably forms a uniform nip width. Controlling the pressing force or pressure of the pressure roller pressing against the nip formation pad 26 enables controlling the nip width of the fixing nip.

With reference to FIG. 2, the length of the nip formation pad 26 in a Z-direction (that is a direction perpendicular to the surface of the paper on which FIG. 2 is drawn) is shorter than the length of the fixing belt 25 in the Z-direction. The nip formation pad 26 has a nip formation face extending in a sheet conveyance direction D1 along which the sheet P is conveyed.

To reduce the sliding friction while the fixing belt 25 slides along the nip formation pad 26, the nip formation pad 26 has both ends of the nip formation face each processed into a round shape, and a fluororesin layer is disposed on a surface contacting the fixing belt 25.

Preferably, the nip formation pad 26 is made of heat-resistant material. The heat-resistant material prevents thermal deformation of the nip formation pad 26 at temperatures in a fixing temperature range desirable to fix the toner image on the sheet P. As a result, the nip formation pad 26 made of heat-resistant material achieves the nip stably and stabilizes output image quality. The heat-resistant material of the nip formation pad 26 may be, for example, typical heat-resistant resin such as polyether sulfone (PES), polyphenylene sulfide (PPS), liquid crystal polymer (LCP), polyether nitrile (PEN), polyamide imide (PAI), and polyether ether ketone (PEEK).

A description of the belt support roller 22 is given below.

The belt support roller 22 is disposed near the nip formation pad 26 and upstream from the nip formation pad 26 in a rotation direction of the fixing belt 25 and is driven to rotate by the rotation of the fixing belt 25. A position of the belt support roller 22 with respect to the nip formation pad 26 defines an angle between the fixing belt 25 and the nip formation face of the nip formation pad 26, that is, the angle between the fixing belt 25 entering the nip formation face and a normal line to the nip formation face of the nip formation pad 26 that is an X-direction surface.

The pressure adjustment roller 23 is described below.

The pressure adjustment roller 23 is disposed downstream from the nip formation pad 26 in the rotation direction of the fixing belt 25 and is driven to rotate by the rotation of the fixing belt 25. A biasing member 29 presses the pressure adjustment roller 23 to press the fixing belt 25 outward and applies tension to the fixing belt 25. The biasing member 29 may be, for example, a compression spring.

The fixing roller 21 is described below.

The fixing roller 21 is disposed upstream from the belt support roller 22 in the rotation direction of the fixing belt 25. A heater 33 is disposed inside the fixing roller 21 to heat the fixing roller 21. The fixing roller 21 heated by the heater 33 heats the fixing belt 25. The heater 33 may include a halogen heater or a nichrome wire.

A controller may control the heater 33 based on, for example, detection results of a surface temperature of the fixing belt 25 that contacts the fixing roller 21. The fixing roller 21 is driven to rotate by the rotation of the fixing belt 25 while the pressure roller 30 contacts the fixing belt 25, but, after the pressure roller 30 separates from the fixing belt 25, the driver coupled to fixing roller 21 independently rotates to rotate the fixing belt 25.

The pressure roller 30 is described below.

The pressure roller 30 is a roller with an elastic layer of, for example, fluoro rubber, silicone rubber, and silicone rubber foam formed on a tubular cored bar made of SUS 304 that is a type of steel use stainless (SUS) defined by Japanese Industrial Standard (MS). A heater as a heat source may be disposed inside the tubular cored bar. The heater disposed inside the tubular cored bar can prevent temperature drop in the fixing nip. The heater may include a halogen heater or a nichrome wire.

The pressure roller 30 is moved in the Y-direction in FIG. 2 by a contact-separation mechanism 60. For example, the movement of the pressure roller 30 in the positive Y-direction causes the pressure roller 30 to contact and press against the nip formation pad 26 via the fixing belt 25 and form the fixing nip. On the other hand, the movement of the pressure roller 30 in the minus Y-direction causes the pressure roller 30 to separate from the fixing belt 25.

The image firming apparatus 100 includes a driver to drive and rotate the pressure roller 30, and the driver rotates the pressure roller 30 in a direction indicated by an arrow D2 in FIG. 2. The pressure roller 30 contacting the fixing belt 25 rotates the fixing belt 25 in a direction indicated by an arrow D3.

The fixing belt 25 is an endless belt having a multilayer structure, such as a two-layered belt including a base and a release layer or a three-layered belt including the base, an elastic layer, and the release layer. Providing the elastic layer on the fixing belt 25 in the three-layer structure causes the surface of the fixing belt 25 to easily adhere to the toner image and enhances the image quality.

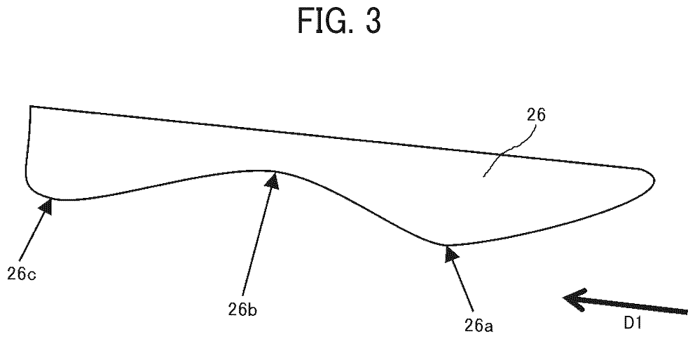

FIG. 3 is an enlarged sectional view of the nip formation pad 26 according to the present embodiment.

As illustrated in FIG. 3, the nip formation face of the nip formation pad 26 to form the fixing nip has three curved portions extending in the sheet conveyance direction D1, which is the X direction, and a direction intersecting the longitudinal direction of the nip formation pad 26. Specifically, the nip formation face of the nip formation pad 26 has a first curved portion 26a, a second curved portion 26b, and a third curved portion 26c arranged in this order from upstream in the sheet conveyance direction as the three curved portions. The nip formation face of the nip formation pad 26 is formed so as to be gradually away from the rotation center of the pressure roller 30 from the first curved portion 26a toward the second curved portion 26b, From the second curved portion 26b toward the third curved portion 26c, the nip formation face is formed so as to approach the rotation center of the pressure roller 30.

In other words, the first curved portion 26a and the third curved portion 26c each have a convex shape protruding toward the pressure roller 30, and the second curved portion 26b has a concave shape away from the pressure roller 30. In other words, the first curved portion 26a protrudes toward the rotation center of the pressure roller 30, the second curved portion 26b downstream of the first curved portion 26a in the sheet conveyance direction is retracted from the rotation center of the pressure roller 30, and the third curved portion 26c downstream of the second curved portion 26b in the sheet conveyance direction protrudes toward the rotation center of the pressure roller 30.

In FIG. 3, a curvature starting point of the third curved portion 26c is positioned at the exit of the fixing nip. The above-described structure can effectively prevent the occurrence of the horizontal white streak.

In addition, the first radius Ra of curvature of the first curved portion 26a is larger than the third radius Re of curvature of the third curved portion 26c (Ra>Re). The above-described structure enlarges a receiving port through which the sheet P enters the fixing nip. As a result, the sheet P can reliably enter the fixing nip.

Additionally, the third radius Rc of curvature of the third curved portion 26c is smaller than the second radius Rb of curvature of the second curved portion 26b (Rc<Rh). The above-described structure enhances a sheet separation performance in that the sheet P separates from the fixing belt 25 or the pressure roller 30 at the exit of the fixing nip.

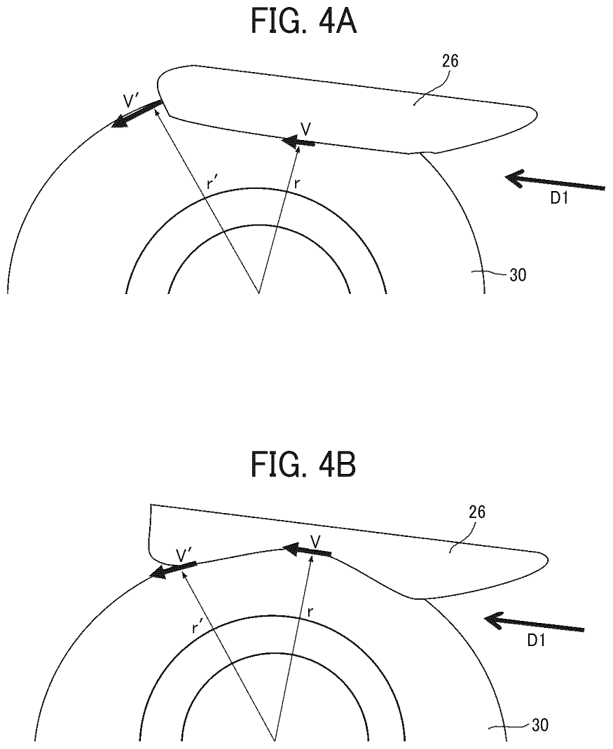

FIG. 4A is a schematic diagram illustrating a configuration of a nip formation pad according to a comparative example. FIG. 413 is a schematic diagram illustrating a configuration of the nip formation pad according to the present embodiment.

In FIG. 4A, the nip formation pad 26 according to the comparative example has curved portions at the entrance of the fixing nip and the exit of the fixing nip and has a flat portion between the entrance and the exit. The deformation amount of the pressure roller 30 at the exit of the fixing nip is different from the deformation amount of the pressure roller 30 in the center of the fixing nip. The above-described structure causes a linear velocity difference (a conveyance velocity difference) between a linear velocity of the sheet at the center of the fixing nip and a linear velocity of the sheet at the exit of the fixing nip, in the comparative example illustrated in FIG. 4A, the linear velocity v′ of the sheet at the exit of the fixing nip is greater than the linear velocity v of the sheet at the center of the fixing nip. The linear velocity difference (v′-v) is larger than zero, that is (v′-v)>0.

The above-described linear velocity difference (v′-v) causes a force that pulls the sheet P toward the exit of the fixing nip. The conveyance velocity of the sheet rapidly increases after the rear end of the sheet passes through the center portion of the fixing nip. As a result, burrs on the rear end of the sheet and a fixed material such as calcium carbonate on the rear end of the sheet are scraped and adhered to the fixing belt 25.

After the fixing belt 25 rotates once, the burrs and the fixed material that are scraped off from the rear end of the sheet and adhered to the fixing belt 25 are transferred to the toner image during a fixing process, causing the occurrence of the abnormal image such as the horizontal white streak extending in a direction orthogonal to the sheet conveyance direction D1.

In contrast, the nip formation face of the nip formation pad 26 in the fixing device according to the present embodiment illustrated in FIG. 4B has three curved portions extending in the sheet conveyance direction D1. The second curved portion 26b has a gently formed concave shape with respect to the pressure roller 30. As a result, the linear velocity difference (v′ v) between the linear velocity v′ of the sheet P at the exit of the fixing nip and the linear velocity v of the sheet P at the center of the fixing nip in the fixing device according to the present embodiment is smaller than that in the fixing device according to the comparative example. In other words, a linear velocity difference between the linear velocity v′ of the sheet P and the linear velocity of the fixing belt at the exit of the fixing nip in the fixing device according to the present embodiment is smaller than that in the fixing device according to the comparative example. The above-described smaller linear velocity difference between the linear velocity v′ of the sheet P and the linear velocity of the fixing belt at the exit of the fixing nip reduces the adhesion of the burrs on the rear end of the sheet and the fixed material such as calcium carbonate on the rear end of the sheet to the fixing belt 25 due to the linear velocity difference and prevents the occurrence of the horizontal white streak. In other words, the pressure roller 30 is separated from the third curved portion 26c of the nip formation pad 26 so that an angular velocity ωb=v/r of the pressure roller 30 at the center of the fixing nip approximates to an angular velocity ωC=v′/r′ of the pressure roller 30 at the exit of the fixing nip to reduce the linear velocity difference between the linear velocity of the fixing belt 25 and the conveyance velocity of the sheet conveyed by the pressure roller 30.

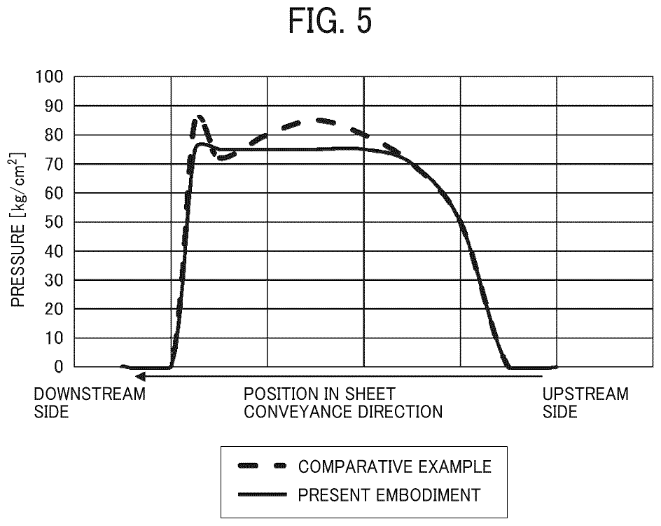

FIG. 5 is a graph illustrating a pressure distribution of the nip formation pad 26 according to the present embodiment of the present disclosure and a pressure distribution of the nip formation pad according to a comparative example, where the surface pressure in the present embodiment is compared with the surface pressure in the present comparative example.

The horizontal axis in FIG. 5 represents positions on the nip formation pad 26 in the sheet conveyance direction. The range in which the surface pressure is larger than 0 corresponds to the fixing nip formed between the pressure roller 30 and the nip formation pad 26 and the nip formation face of the nip formation pad 26. The range in which the surface pressure is 0 is not the fixing nip and the nip formation face. The sheet conveyance direction is from right to left in FIG. 5.

The nip formation pad according to the present comparative example increases the deformation amount of the pressure roller at the exit of the fixing nip (that is, a downstream position in the sheet conveyance direction in FIG. 5) to increase the surface pressure applied to the rear end of the sheet. Eliminating a non-pressure region at the exit of the fixing nip prevents the occurrence of gloss unevenness (that is, the river mark) due to the wavy deformation of the sheet P. However, pressing the nip formation pad to the pressure roller at the exit of the fixing nip to form the above-described pressure distribution causes the above-described abnormal image (that is, the horizontal white streak).

In contrast, the shape of the nip formation pad 26 according to the present embodiment determines the pressure distribution. As a result, the above-described structure according to the present embodiment can eliminate the non-pressure region at the exit of the fixing nip without forcibly pressing the nip formation pad 26 to the pressure roller at the exit of the fixing nip. In other words, since the nip formation face of the nip formation pad 26 approaches the rotation center of the pressure roller 30 from the center of the fixing nip toward the exit of the fixing nip, the surface pressure distribution becomes uniform from the center of the fixing nip toward the exit of the fixing nip. As a result, the nip formation pad according to the present embodiment can prevent the occurrence of gloss unevenness (that is, the river mark) due to the wavy deformation of the sheet P.

In addition, as described with reference to FIG. 4, the nip formation pad 26 according to the present embodiment reduces the linear velocity difference (v′ v) between the linear velocity of the sheet at the center of the fixing nip and the linear velocity of the sheet at the exit of the fixing nip, which prevents the occurrence of the horizontal white streak. As a result, the nip formation pad according to the present embodiment can prevent the occurrence of both the river mark and the horizontal white streak.

As described above, the fixing device 20 according to the present embodiment includes the nip formation pad having the nip formation face with the central portion in the sheet conveyance direction gently recessed. Specifically, the nip formation face of the nip formation pad 26 has three curved portions extending in the sheet conveyance direction D1. The three curved portions are the first curved portion 26a, the second curved portion 26b, and the third curved portion 26c arranged in this order from upstream in the sheet conveyance direction. The nip formation face of the nip formation pad 26 is recessed so as to be gradually away from the rotation center of the pressure roller 30 from the first curved portion 26a disposed upstream from other curved portions in the sheet conveyance direction toward the second curved portion 26b. From the second curved portion 26b toward the third curved portion 26c, the nip formation face expands so as to approach the rotation center of the pressure roller 30, The above-described structure can prevent the occurrence of abnormal images such as the river mark and the horizontal white streak.

Aspects of the present disclosure are, for example, as follows.

First Aspect

In a first aspect, a fixing device includes a belt, a nip formation pad, and a pressure rotator. The belt has a loop rotatable in a sheet conveyance direction. The nip formation pad is inside the loop. The nip formation pad includes three curved portions in the sheet conveyance direction. The three curved portions form a nip formation face. The pressure rotator presses the belt against the nip formation pad to form a fixing nip between the belt and the pressure rotator.

Second Aspect

In a second aspect, the three curved portions in the fixing device according to the first aspect include a first curved portion, a second curved portion, and a third curved portion. The first curved portion protrudes toward a rotation center of the pressure rotator. The second curved portion is downstream of the first curved portion in the sheet conveyance direction and retracted from the rotation center of the pressure rotator. The third curved portion is downstream of the second curved portion in the sheet conveyance direction and protrudes toward the rotation center of the pressure rotator.

Third Aspect

In a third aspect, a curvature starting point of the third curved portion in the fixing device according to the second aspect is at an exit of the fixing nip.

Fourth Aspect

In a fourth aspect, the first curved portion has a first radius of curvature, the third curved portion has a third radius of curvature, and the first radius of curvature is larger than the third radius of curvature in the fixing device according to the second aspect or the third aspect.

Fifth Aspect

In a fifth aspect, the third curved portion has a third radius of curvature smaller than the second radius of curvature of the second curved portion in the fixing device according to any one of the second to fourth aspect.

Sixth Aspect

In a sixth aspect, an image forming apparatus includes the fixing device according to any one of the first to fifth aspects.

The above-described embodiments are illustrative and do not limit the present disclosure. Thus, numerous additional modifications and variations are possible in light of the above teachings. For example, elements and; or features of the embodiment and variation may be combined with each other and/or substituted for each other within the scope of the present disclosure.

The advantages achieved by the embodiments described above are examples and therefore are not limited to those described above.

1. A fixing device comprising:
a belt having a loop rotatable in a sheet conveyance direction;
a nip formation pad inside the loop, the nip formation pad including three curved portions in the sheet conveyance direction, the three curved portions forming a nip fbrmation face; and
a pressure rotator to press the belt against the nip formation pad to form a fixing nip between the belt and the pressure rotator.

2. The fixing device according to claim 1,
wherein the three curved portions include:
a first curved portion protruding toward a rotation center of the pressure rotator;
a second curved portion downstream of the first curved portion in the sheet conveyance direction, the second curved portion retracted from the rotation center of the pressure rotator; and
a third curved portion downstream of the second curved portion in the sheet conveyance direction, the second curved portion protruding toward the rotation center of the pressure rotator.

3. The fixing device according to claim 2,
wherein a curvature starting point of the third curved portion is at an exit of the fixing nip.

4. The fixing device according to claim 2,
wherein the first curved portion has a first radius of curvature,
the third curved portion has a third radius of curvature, and
the first radius of curvature is larger than the third radius of curvature.

5. The fixing device according to claim 2,
wherein the third curved portion has a third radius of curvature smaller than the second radius of curvature of the second curved portion.

6. An image forming apparatus comprising the fixing device according to claim 1.
